(19) United States
(12) Patent Application Publication
(10) Pub. No.: US 2007/0162544 A1
(43) Pub. Date: Jul. 12, 2007

(54) Method of and a system for accepting user-created content on a computer network site

(76) Inventor: Steven Rosenbaum, New York, NY (US)

Correspondence Address: Ilya Zborovsky, 6 Schoolhouse Way, Dix Hills, NY, 11746, US

(21) Appl. No.: 11/241,621

(22) Filed: Oct. 3, 2005

(51) Int. Cl. G06F 15/16

(52) U.S. Cl. 709/204

(57) ABSTRACT

Accepting a user-created content on a computer network site includes submitting a content by a submitter, receiving the submitted content from the submitter; reviewing the submitted content by jurors to accept or to reject the content; and if the concept is accepted, making it accessible for users.

### BACKGROUND OF THE INVENTION

The present invention relates to a method of and the system for accepting user-created content on a computer network site.

Media centric communities are places where people go to consume, create or share content. They can include websites, blogs, TV networks, music services, or magazine print publishers, and news services.

The problem they all face is that as the volume of user-created content continues to grow, it becomes impossible to review and filter all of the submissions. It is therefore believed to be advisable to provide a method and a system which eliminates this disadvantage and provides for a possibility of efficiently review and filter all of the submissions so as to accept or to reject the corresponding submissions. Furthermore, the results of the jurors are gathered, stored, and used as valuable meta-data in a centralized meta-data server.

### SUMMARY OF THE INVENTION

Accordingly, it is an object of the present invention to provide a method of and a system for accepting user-created content on a computer network site, which eliminate the disadvantages of the prior art.

In keeping with these objects and with others which will become apparent hereinafter, one feature of the present invention resides, briefly stated, in a method of accepting user-created content on a computer network site, comprising the steps of submitting a content by a submitter; receiving the submitted content from the submitter; reviewing the submitted content by jurors to accept or to reject the content; and if the content is accepted, making it accessible for users.

In accordance with one embodiment of the invention, after said submitting, the submitter is asked to help identify a content=s target audience.

In accordance with another embodiment of the invention, the submitter identifies the content=s target audience by selecting a targeting from a group consisting of experience, level, genre of content and level of sophistication.

In accordance with still another embodiment of the invention, said reviewing of the submitted content includes rating the content.

In accordance with a further embodiment of the invention, rating the content includes rating the content based on a variable selected from the group consisting of quality, accuracy, interest, video quality, audio quality, length, appropriateness to target audience, and combinations thereof.

In accordance with a further embodiment of the invention, averaging of the rates obtained from the jurors is performed and a decision to accept or reject the content is based on the averaged rate.

In accordance with still a further embodiment of the invention, a bar is set as to what a threshold is for acceptance or rejection of the content.

In accordance with still a further embodiment of the invention, in the event if the content is rejected, judges comments are forwarded to the submitter with a suggestion for resubmission of the content.

In accordance with another embodiment of the invention, the suggestion is selected from the group consisting of adjustment of target audience goals and modification of the content.

In accordance with additional embodiment of the invention, the adjusted content can be resubmitted for reviewing by the jurors.

In accordance with still additional embodiment of the invention, in the event if the content is approved, searchers have access to the approved content.

Another feature of the present invention also resides in a system for accepting user-created content on a computer network site, comprising means for submitting a content by a submitter; means for receiving the submitted content; means for reviewing the submitted content by jurors to accept or to reject the content; and means for making the content accessible for users if it is accepted.

A further feature of the present invention resides in a computer-readable medium for implementing a method of accepting a user-created content, the method comprising the steps of submitting a content by a submitter; receiving the submitted content from the submitter; reviewing the submitted content by jurors to accept or to reject the content; and if the concept is accepted, making it accessible for users.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a block diagram illustrating an exemplary computer network for implementing certain embodiments of the present invention; and

FIG. 5 is a flow chart of an exemplary process for accepting user-created content in accordance with the present invention.

### DESCRIPTION OF THE PREFERRED EMBODIMENTS

In accordance with the present invention, an operator may set up a computer network site accessible by various content submitters, jurors, and searches or users as will be explained herein below. The network of site may be for example a website accessible over the Internet or World Wide Web.

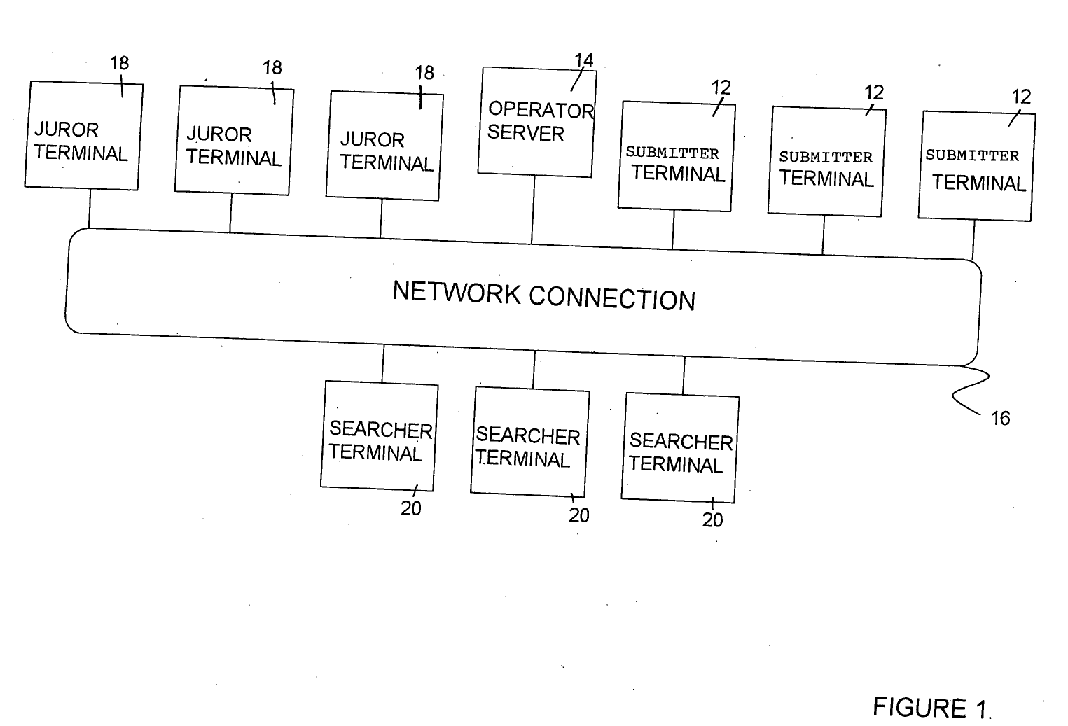

FIG. 1 shows an example of a computer network 10. Content submitters may communicate through a plurality of submitter operated terminals 12 with one or more operator servers 14 over a network connection 16. The computer network 10 is preferably an Internet-based network such as the World Wide Web. It may be one or more of a local area network (LAN), a wide area network (WAN), intranet environment, an extranet environment, a wireless network or any other type of computer network, such as those enabled over public switched telephone networks.

Reference numerals 18 identifies juror terminals that are also connectable with the operator server 12 over the network connection 16, to participate in the process implemented by the method and system of the present invention. A plurality of searcher or user terminals 20 are provided and also may be connected with the operator server 14 via the network connection 16.

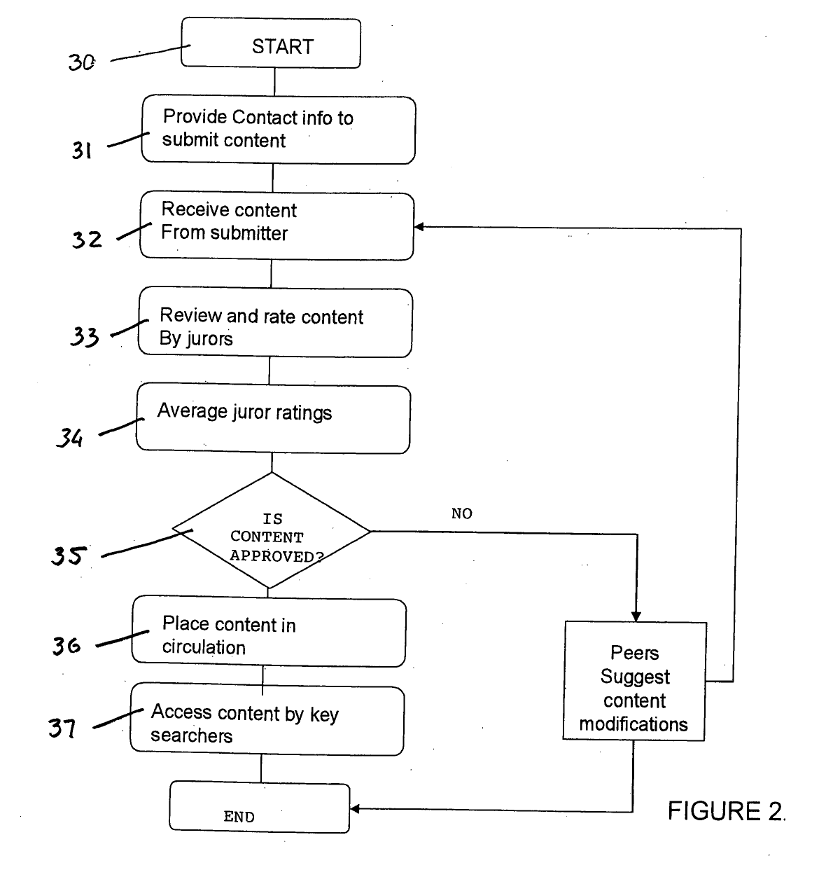

Turning now to FIG. 5, an exemplary process 30 for accepting a user-created content implemented in the inventive system is illustrated in this drawing. The process 30 begins at step 31 where the network site maintained by the operator server 14 provides submitters with one or more fields to submit content, with submitter information, contact information, and one or more contents.

Continuing with process 30, a submitter submits a proposed content to the operator of the operator server 14 in step 32. Once the content is submitted, the submitter can be asked to help identify the content=s target audience. This targeting can include experience level, genre of content, and level of sophistication.

In step 33 the content is reviewed and rated by jurors. The operator of the server 14 convenes an adhoc jury, for example of five random members. These members are each send a link to the received content, which is not available to general membership. The new jurors can fill out a form that provides a profile of their experience level, the length of commitment to the content area, and some quantatatable data about their validity as a juror.

Each juror reviews the content, and then rates the content based on quality, accuracy, interest, video quality, audio quality, length appropriateness to target audience and other variables that can be chosen by individual content community.

The software then averages the votes in step 34. It remove outliners, and sends the decision of the jurors to the submitter. The operator/owner/manager can set a bar as to what the threshold is for acceptance or rejection.

In step 35 a decision is made whether the content is accepted or rejected. If the content is rejected, the jurors comments are forwarded to the submitter with a suggestion to adjust the content, so that for example the target audience goals can be adjusted or the content can be modified. The content can be then resubmitted for judging.

In the event if the content is approved for the community, then it is placed into circulation in step 36. The comments of the jurors can be attached to the content as meta-data.

Searchers are then allowed in step 37 to have access to the content with impartial, valid, anonymous data

It will be understood that each of the elements described above, or two or more together, may also find a useful application in other types of constructions differing from the types described above.

While the invention has been illustrated and described as embodied in a method of and a system for accepting user-created content on a computer network site, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of accepting user-created content on a computer network site, comprising the steps of submitting a content by a submitter; receiving the submitted content from the submitter; reviewing the submitted content by jurors to accept or to reject the content; and if the concept is accepted, making it accessible for users.

2. A method as defined in claim 1; and further comprising, after said submitting, asking the submitter to help identify a content=s target audience.

3. A method as defined in claim 2, wherein said asking the submitter to help identify the content=s target audience includes selecting a targeting from a group consisting of experience, level, genre of content and level of sophistication.

4. A method as defined in claim 1, wherein said reviewing the submitted content includes rating the content.

5. A method as defined in claim 4, wherein rating the submitted content includes rating the content based on a variable selected from the group consisting of quality, accuracy, interest, video quality, audio quality, length, appropriateness to target audience, and combinations thereof.

6. A method as defined in claim 4; and further comprising averaging of the rates obtained from the jurors and making a decision to accept or reject the content based on the averaged rate.

7. A method as defined in claim 1; and further comprising setting a bar as to what a threshold is for acceptance or rejection of the content.

8. A method as defined in claim 1; and further comprising in the event if the content is rejected, forwarding jurors comments to the submitter with a suggestion for resubmission of the content.

9. A method as defined in claim 8; and further comprising selecting the suggestion from the group consisting of adjustment of target audience goals and modification of the content.

10. A method as defined in claim 8; and further comprising resubmitting the adjusted content for reviewing by the jurors.

11. A method as defined in claim 1; and further comprising in an event if the content is approved, allowing for searchers to have access to the approved content.

12. A method as defined in claim 10, wherein said making available includes making available the approved content with comments by the jurors attached to the content.

13. A system for accepting user-created content on a computer network site, comprising means for submitting a content by a submitter; means for receiving the submitted content; means for reviewing the submitted content by jurors to accept or to reject the content; and means for making the content acceptable for users, if it is accepted for implementing a method of accepting a user-created content on a computer network site.

14. A computer readable medium for implementing a method of accepting a user-created content on a computer network site, the method comprising receiving a proposed content from a transmitter; reviewing the submitted content by jurors to accept or to reject the content; and if the concept is accepted, making it accessible for users.
